(19) United States
(12) Patent Application Publication
(10) Pub. No.: US 2003/0160957 A1
(43) Pub. Date: Aug. 28, 2003

(54) Scanning system and method for scanning a plurality of samples

(75) Inventors: Mark F. Oldham, Los Gatos, CA (US); Eugene F. Young, Marietta, GA (US)

Correspondence Address: MILA KASAN, PATENT DEPT., APPLIED BIOSYSTEMS, 850 LINCOLN CENTRE DRIVE, FOSTER CITY, CA, 94404, US

(73) Assignee: Applera Corporation, Foster City, CA

(21) Appl. No.: 10/369,881

(22) Filed: Feb. 19, 2003

Related U.S. Application Data
(63) Continuation-in-part of application No. 09/617,549, filed on Jul. 14, 2000, now Pat. No. 6,563,581.

(51) Int. Cl. G01J 3/30

(52) U.S. Cl. 356/317

(57) ABSTRACT

A system for detecting fluorescence emitted from a plurality of samples placed in a plurality of sample wells in a detection system. The detection system may include either a single lens which may be used to focus excitation beams on one or a plurality of the sample wells. Alternatively, a plurality of lenses may be placed in a housing and may be used to focus one or a plurality of excitation beams onto one or a plurality of sample wells. In addition, splitters or diffusers may be used to split a single excitation beam into a plurality of excitation beams to excite a plurality of sample wells simultaneously. Therefore, a plurality of sample wells may be excited and detected simultaneously rather than consecutively. The sample wells may generally be arranged in arrays having a plurality of geometries. Specifically, sample wells may be arrayed in rectangular, square, circular, or spiral geometries.

### CROSS REFERENCE TO RELATED APPLICATIONS

This is a continuation-in-part of U.S. patent application Ser. No. 09/617,549 entitled “Scanning System and Method for Scanning a Plurality of Samples,” filed on Jul. 14, 2000 to Mark F. Oldham and Eugene F. Young.

### FIELD

This invention relates to systems and methods for scanning a sample tray with a plurality of samples. The invention further relates to detection systems for detecting fluorescence from the plurality of samples in the sample tray.

### BACKGROUND

Biological testing involving analyzing the chemical composition of nucleic acid samples in order to determine the nucleotide sequence of the sample has become increasingly popular. Currently, experiments in chemistry and biology typically involve evaluating large numbers of samples using techniques such as detection of fluorescence emitted from a sample in conjunction with a polymerase chain reaction (PCR). These experiments, as well as other techniques such as sequencing of nucleic acid samples, are typically time consuming and labor intensive. Therefore, it is desirable that a large number of samples can be analyzed quickly and accurately.

### SUMMARY

Various advantages and purposes will be set forth in part in the description which follows, and in part will be obvious from the description, or may be learned by practice of the following description. The advantages and purposes will be realized and attained by the elements and combinations particularly pointed out in the appended claims.

According to various embodiments a system to detect fluorescence from a plurality of samples placed on a sample stage includes a sample platform. A plurality of sample wells are defined by the sample platform. The term “sample well” refers to any sample holding area, material for containing sample, or point of interrogation on the sample platform. Samples may be placed in the sample wells in a selected arrangement relative to the sample platform. At least one focusing element is operationally alignable with at least one of the sample wells. The focusing element is selectively alignable and unalignable relative to the sample holding area. An excitation source produces an excitation energy wave that is focused by focusing element into a selected holding area when the focusing element is aligned. A detection system detects a selected emitted energy from the sample placed in the sample holding area. At least one of the sample platform and the focusing element is moved to align or unalign the focusing element.

According to various embodiments an excitation system to excite a plurality of sample areas substantially simultaneously includes an excitation energy source, wherein the excitation energy source is able to produce a selected energy. An initial excitation beam of the selected energy is directed in a first selected direction. An optical element is placed in the selected direction to diffuse or split the initial excitation beam into a plurality of secondary excitation beams. A focusing element focuses at least one of the secondary excitation beams in a second selected direction.

According to various embodiments a sample platform to be used in an excitation and detection system includes a plurality of samples placed on the sample platform to be excited and detected in a selected manner. The sample platform includes a substantially planar disc formed of a material suitable for use in an optical detection system. A plurality of sample wells are formed on the disc. The disc includes an axis of rotation about which the sample wells rotate such that each sample well passes a selected point relative to the disc. The sample wells are arranged in a selected pattern on the disc.

According to various embodiments a method of using a detection system having a lens to direct an energy emitted by an excited sample placed on a sample platform to a light detection device includes disposing a plurality of sample wells on the sample platform. The sample wells are moveable relative to the light detection device. An energy beam is directable toward the sample platform. The energy beam is focused on at least a selected one of the sample wells or well such that a sample in the selected sample holding area produces an emitted fluorescence. The sample wells are moved to allow the energy beam to be focused on each of the plurality of sample wells. An emitted fluorescence from the sample wells is then detected.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain principles of the invention. In the drawings,

FIG. 1 is a front schematic view of a system for scanning a plurality of sample wells and measuring the fluorescence of the samples therein according to various embodiments;

FIG. 2 is a side schematic view of the system of FIG. 1;

FIG. 3 is a close up side schematic view of a portion of an optical system;

FIG. 4 is a close up front schematic view of a portion of an optical system;

FIG. 5 is a side view of a system according to various embodiments;

FIG. 6 is a top view of the system of FIG. 5; and

FIGS. 7A-7F illustrate a method of scanning the sample wells in a sample well tray according to various embodiments.

FIG. 8 is a close up top schematic view of a scanning system according to various embodiments;

FIGS. 9-13 are top schematic views illustrating a plurality of sample well disks according to various embodiments;

FIG. 14A is a top schematic view of a method of scanning a plurality of sample wells according to various embodiments;

FIG. 14B is a side detailed view of the system illustrated in FIG. 14A;

FIG. 15A is a top schematic view of a scanning system according to various embodiments; and

FIG. 15B is a side detailed view of the system illustrated in FIG. 15A.

### DESCRIPTION OF VARIOUS EMBODIMENTS

Reference will now be made in detail to various embodiments, examples of which are illustrated in the accompanying drawings. Wherever possible, the same reference numbers will be used throughout the drawings to refer to the same or like parts.

According to various embodiments, a scanning system for detecting fluorescence emitted from a plurality of samples in a sample tray is described. Alternatively, a single sample with a plurality of probes may be provided. For example, a single sample may be provided with a different probe present in each sample well. According to various embodiments of the invention, the optical system generally includes a plurality of lenses positioned in a linear arrangement, an excitation light source for generating an excitation light, an excitation light direction mechanism for directing the excitation light to a single lens of the plurality of lenses at a time so that a single sample well aligned with the well lens is illuminated at a time and an optical detection system for analyzing light from the sample holders. The excitation light source directs the excitation light to each of the sample holders of a row of sample holders in a sequential manner as the plurality of lenses linearly translates in a first direction relative to the sample tray, the sample holder generating light upon illumination. The plurality of lenses, the sample tray or a combination of the two may be translated, so that a relative motion is imparted between the plurality of lenses and the sample tray.

The present description further provides methods of scanning a sample well tray, which has a plurality of samples positioned in sample holders, to detect fluorescence. The method includes generating an excitation light with an excitation light source, and directing the excitation light to a first lens of a row of lenses, the row of lenses being angularly offset relative to an adjacent row of sample holders. The method further includes illuminating a sample in a first sample holder of the row of sample holders positioned adjacent the row of lenses with the excitation light to generate an emission light, and optically detecting the spectral characteristics of the emission light. The method includes directing the excitation light to a second lens positioned adjacent the first lens of the row of lenses, illuminating a sample in a second sample holder of the row of sample holders to generate an emission light, and optically detecting the spectral characteristics of the emission light from the second sample holder. According to various embodiments, the row of lenses is linearly translated in a direction substantially perpendicular to the row of sample holders throughout the above methods. In various embodiments, the row of sample holders is linearly translated relative to the row of lenses. In various embodiments, the sample holders are sample wells.

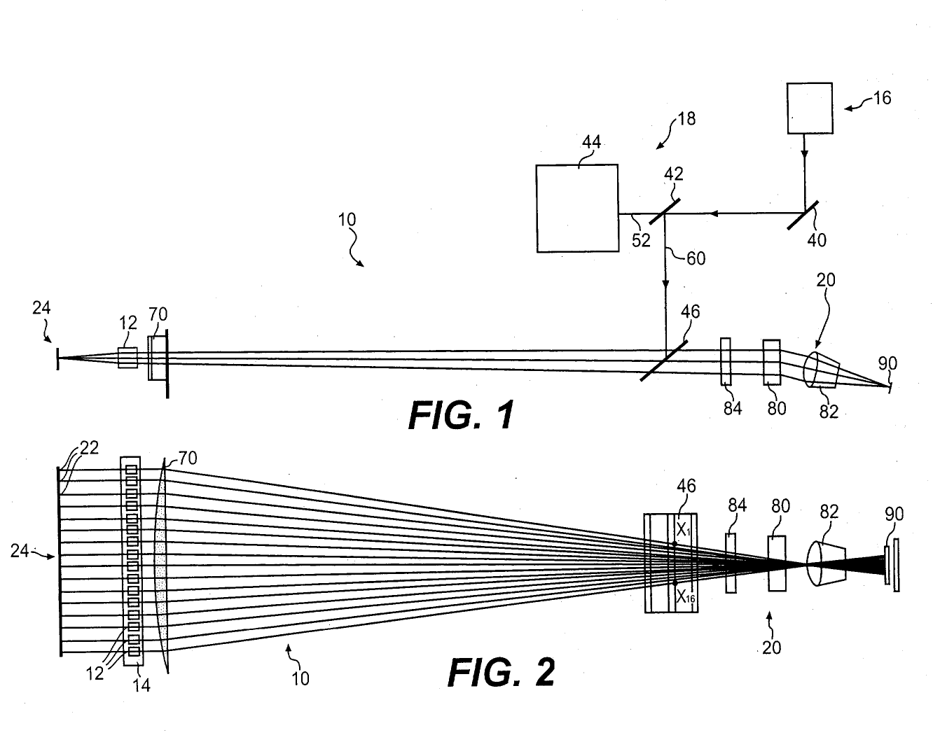

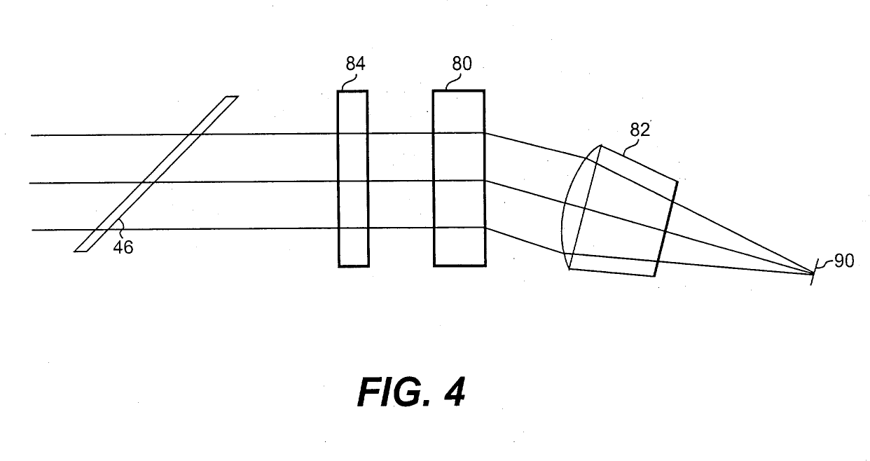

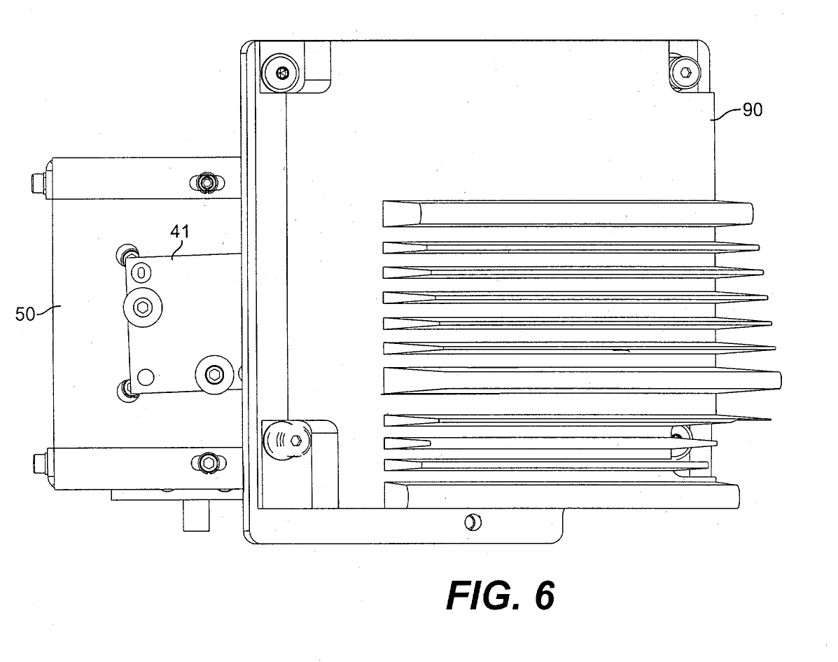

According to various embodiments shown in FIGS. 1-7, the scanning system 10 for detecting fluorescence includes a plurality of well lenses 12 positioned in a well lens housing 14, an excitation light source 16, an excitation light directing mechanism 18 for directing the excitation light to a single well lens at a time, and an optical detection system 20 for analyzing light from the sample wells 22 of the sample well tray 24 or other sample holding device. The well lens 12 disposed in the well lens housing 14 define a focusing element. According to various embodiments, a focusing element may include a single lens, grating or other appropriate element that can focus an excitation beam 60, discussed further herein. Moreover, the focusing element may differ depending upon the excitation light source 16 and the width of the excitation beam 60. The plurality of well lenses may also be formed as a molded lens array. The well lens housing 14 may be moved by an appropriate focusing element or housing moving device. For example, a mechanical armature or a magnetic device.

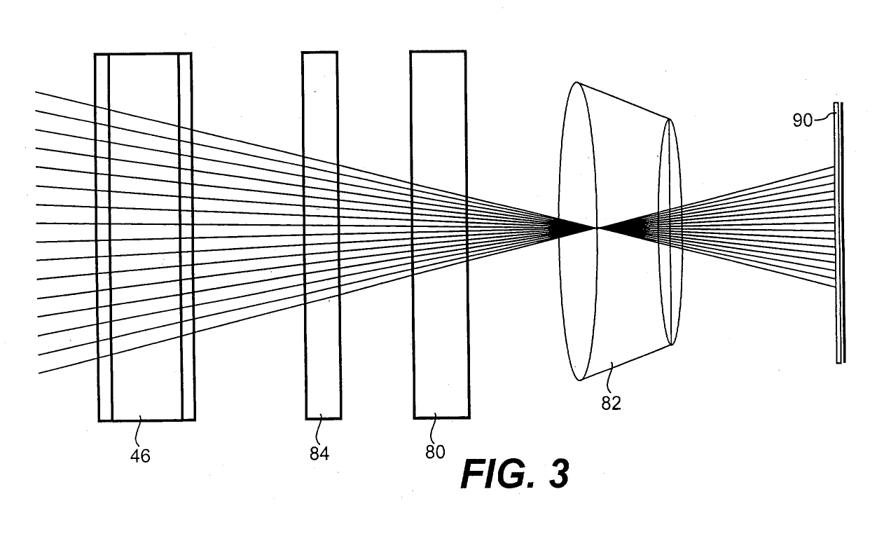

In accordance with various embodiments, the scanning system includes a plurality of lenses, hereinafter referred to as well lenses, positioned in a linear arrangement. According to various embodiments and shown in FIGS. 1-5, the plurality of well lens 12 are positioned within a well lens housing 14. In various embodiments, the well housing contains a single row of well lenses 12 arranged so that the well lenses are equally spaced from each other, as shown in FIG. 2. The well lenses 12 are arranged in a linear manner within the well housing. The well lens are arranged so that each of the well lenses will align with a corresponding column of sample wells in a sequential manner as the well lens housing is linearly translated relative to an adjacent sample well tray. Throughout the scanning of the sample well tray, the well lens housing moves at a substantially uniform speed relative to the sample well tray in a plane parallel to the top surface of the sample well tray. For example, the well lens housing 14 in FIG. 2 moves in a first direction (into the page in FIG. 2) as the well lens housing 14 linearly translates in a plane parallel to the top surface of sample well tray 24. In other embodiments, the sample well tray is linearly translated relative to a stationary well lens housing.

The well lens housing may be positioned adjacent a sample well tray with a plurality of sample wells to be scanned. As shown in FIG. 2, the well lens housing is positioned adjacent a stationary sample well tray 24 with a plurality of sample wells 22. According to various embodiments, the sample well tray 24 has a number of columns equal to the number of well lenses in the well lens housing. In the example shown, the sample well tray is a 384-well tray. In a 384-well sample well tray, the wells are arranged in a sixteen by twenty-four array with sixteen columns and twenty-four rows. The scanning device may also be configured for use with sample trays including any appropriate number of wells such as 1536, 96, 48, and 24 in addition to microcard sample trays.

Any appropriate generally known sample well trays may be used. Examples of microcard sample trays suitable for use in the apparatus of the present invention are described in PCT Application No. WO97/36681 to Woudenberg et al., which is assigned to the assignee of the present application, the contents of which are hereby incorporated by reference herein for any purpose. Sample well trays having any number of sample wells and sample well sizes may also be used. According to various embodiments, the volume, area and/or capacity of the sample wells may vary substantially, but generally are able to contain at least 0.01 μl in volume. The scanning system may be used for a variety of applications, such as, but not limited to, fluorescent PCR-based detection.

Likewise, although various embodiments employ trays with sample wells, various embodiments are suitable for use with sample trays that do not include wells. The tray may include any type of sample holder that can maintain a sample in a fixed position on a tray. In various embodiments, the sample trays may have a flat surface on which a sample of biological material is placed. The flat surface on which the sample is placed may be similar to a microscope slide for a sample. In this type of sample tray, a liquid may be dropped onto the tray at a plurality of positions, and then a film or cover positioned on the top surface of the tray over the samples. Alternately, a sample tray may include a porous material such as a frit on the top surface, instead of sample wells, for holding samples of biological material. Therefore, although the description refers to sample well trays throughout, it should be understood that various embodiments are also suitable for sample trays that do not have sample wells.

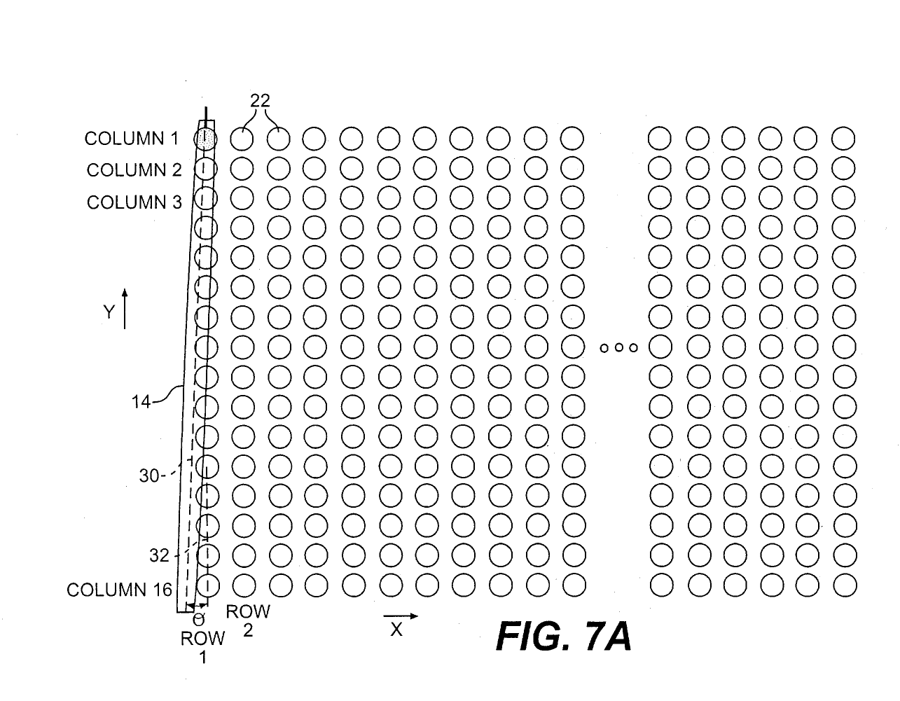

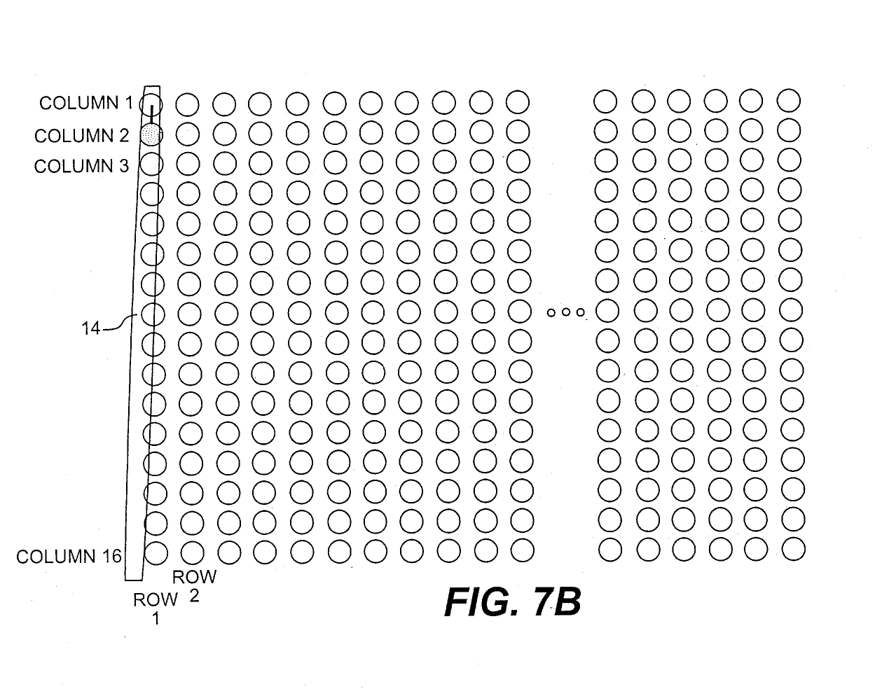

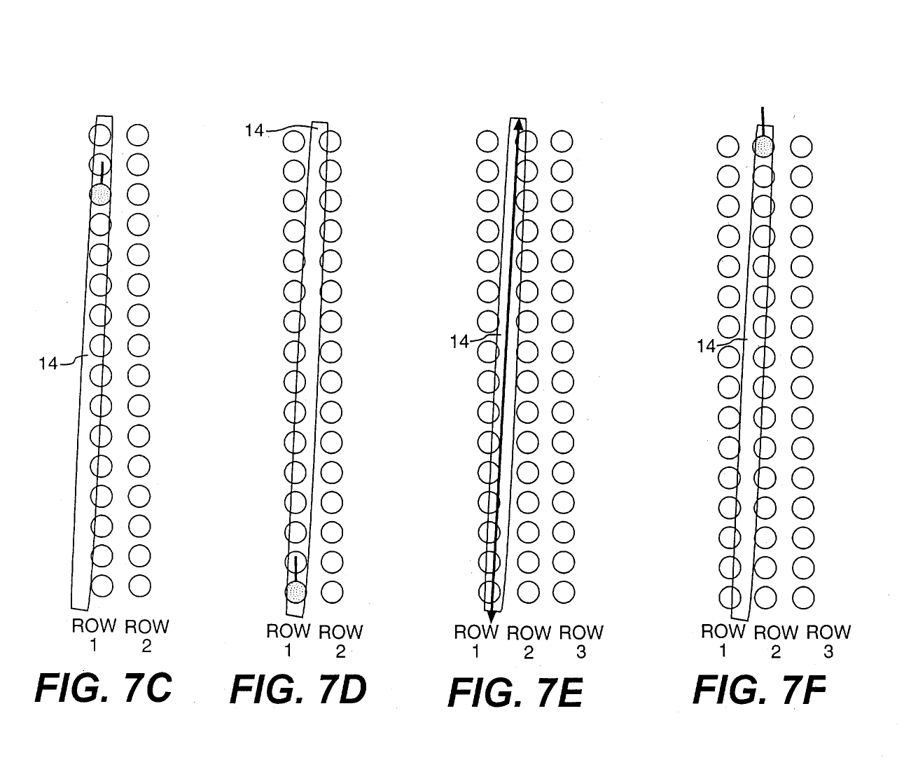

For purposes of illustration only, the sample well tray described is a 384-well tray arranged in the sixteen by twenty-four array shown in FIG. 7A. For a 384-well sample tray with a conventional sixteen by twenty-four array, it is desirable to have sixteen well lenses in the well lens housing. Each well lens corresponds to a particular column of the sample well tray 24. For example, as shown in FIG. 7A, the first well lens of the row of well lenses corresponds to the first column of the sample well tray. Likewise, the second well lens of the row of well lenses corresponds to the second column of the sample well tray, and so forth.

In accordance with various embodiments, the row of well lenses are configured to be offset at an acute angle relative to a linear row of sample wells arranged in a first direction in a sample well tray. According to various embodiments and shown in FIG. 7A, the well lens housing 14 (and row of well lenses 12) is arranged on a centerline 30 that passes through the center of each of the well lenses. The centerline 30 of the row of well lenses 12 is arranged to be offset at a predetermined angle θ relative to a centerline 32 passing through the first row of sample wells as shown in FIG. 7A. In various embodiments, the angular offset θ between the row of well lenses and the row of sample wells allows the scanning system to operate by the desired method.

In view of the arrangement of the well lens housing and well lenses relative to the sample well tray, an excitation light can pass through the first well lens when the well lens is aligned with the first sample well (column 1) of the first row of the sample well tray, as shown in FIG. 7A. The first sample well is thereby illuminated, generating an emission light that is analyzed by an optical system. As the well lens housing continues to translate at a substantially uniform speed in the x-axis direction to the position shown in FIG. 7B, an excitation light is passed through a second well lens when the second well lens is aligned with the second sample well of the first row as shown in FIG. 7B. An excitation light direction mechanism according to certain embodiments of the present invention directs the excitation light from one well lens to another in a sequential manner. The excitation light should be directed to the respective well lens at the time at which the well lens is substantially aligned with an adjacent sample well. This process continues so that all of the sample wells in the first row are scanned, and then continues to the next row, thereby scanning all of the sample wells in the second row. This process continues until all of the sample wells are scanned.

In certain embodiments, the angle θ between the row of sample wells and the row of well lenses is selected as a function of the number of sample wells and the spacing between adjacent sample wells. In the configuration shown in FIG. 7A, the angle θ is selected to be between one and three degrees, preferably approximately two degrees. In various embodiments, this is a suitable angle for a sample well tray having spacing of 4.5 mm and sixteen sample wells in each row. In various embodiments, the angle is selected so that an entire row is scanned before any of the well lenses are aligned with the next row to be scanned. The value for the angle θ can vary for each specific design and is not limited by the range described above. For example, in a 96-well format with one particular design, the angle θ is selected to be approximately four degrees.

In accordance with various embodiments, the well lens housing may be translated relative to a stationary sample well tray by a linear actuator or other device. Alternately, the well lens housing may be stationary and the sample well tray translated relative to the stationary well lens housing. The operation and principles are typically identical with either configuration. For purposes of illustration only, the present description is directed toward the embodiments with a well lens housing being translated relative to a stationary sample well tray.

In various embodiments with a stationary sample well tray, the well lens housing is typically linearly translated in a plane substantially parallel to the top of the sample well tray. As shown for example in FIG. 2, the well lens housing 14 may be translated in a first direction (into the page in FIG. 2) relative to the sample well tray 24. In various embodiments, the well lens housing 14 is translated at a substantially uniform speed relative to the stationary sample well tray 24. As shown in FIGS. 7A-7F, the sample well tray translates along the sample well tray 12. It will be understood that the well lens housing 14 may alternatively translate along sample well tray 12. According to various embodiments, both the well lens housing 14 and the sample well tray 12 may translate relative one another.

According to various embodiments of the present invention, the well lens housing translates at a uniform speed so that the scanning device does not undergo the accelerations associated with stopping and starting during an intermittent motion. Therefore, the well lens housing does not dwell over each individual sample well, but instead moves at a substantially constant speed. The well lens housing moves at a sufficiently slow speed that the optical system is able to obtain an accurate analysis of each sample well. In certain examples where the angle θ is 2 degrees, the well lens housing is translated at a predetermined speed so that the well lens is aligned with the corresponding sample well for approximately 5 milliseconds. The alignment time is determined by θ combined with the scan speed of the well lens housing 14 relative to the sample tray 12, which may be selected as desired to achieve optimal results. In various embodiments where the sample concentration is low, the alignment time may be more than 5 milliseconds up to any selected time. In various embodiments where maximum sample throughput and speed are desired, the alignment time may be as low as any appropriate selected time period.

The well lens housing 14 and scanning system 10 may be translated by any suitable type of linear actuator, such as a motor driven carriage assembly. Alternately, as mentioned above, the sample well tray may be translated relative to a stationary well lens housing. In certain embodiments in which the well lens housing 14 translates relative to a stationary sample well tray, the well lens housing 14 may be positioned on a scanning carriage with a screw actuator for linearly translating the scanning carriage. The screw actuator is typically rotated by a motor or other device, and the scanning carriage may slide on one or more guide rods. Other types of linear actuators may also be suitable with the present invention.

In various embodiments, the plurality of lenses may be joined together into an integral lens. In various alternate embodiments, a single lens, such as a cylindrical lens, may be used instead of a plurality of well lenses. In such an arrangement, the single lens would be positioned at approximately the same location as the plurality of well lenses described above. The excitation light will be allowed to pass through the cylindrical lens to the sample well tray, and the excitation light will pass back through toward the optical detection system. The use of a single lens has an advantage of requiring less-precise timing for the excitation light to strike the respective sample well. However, in various embodiments, a single lens may suffer from reduced optical quality compared to the multiple well lens configuration shown in the figures. It will be understood that a lens array, including a plurality of lenses, may also be used.

In accordance with various embodiments of the present invention, the scanning system 10 includes the excitation light source 16 that generates an excitation light to illuminate the samples in the sample wells, as shown in FIG. 1. According to various embodiments, the excitation light source 16 includes a source of visible light. Alternatively, sources of non-visible energy may be used. For example, infrared and ultraviolet energy sources may be included as the excitation light source 16. Regardless, the excitation light source 16 provides a source of excitation energy and the excitation beam 60, discussed herein. In various embodiments, excitation is provided to the sample by an Argon ion laser. Other types of conventional light sources may also be used. The excitation source is typically selected to emit excitation light at one or several wavelengths or wavelength ranges. In certain examples, a laser having a wavelength of 488 nm is used for generating the excitation light. In various embodiments, lasers of various wavelengths may be used. According to various other embodiments, non-laser light or energy sources are also provided. The excitation light from excitation light source 16 may be directed to the well lenses by any suitable manner. In various embodiments, the excitation light is directed to the well lenses by using one or more mirrors to reflect the excitation light at the desired well lens. After the excitation light passes through the well lens into an aligned sample well, the sample in the sample well is illuminated, thereby emitting an excitation emission or emitted light. The emission light can then be detected by an optical system. The excitation light is then directed to another well lens so that a second sample well may be illuminated.

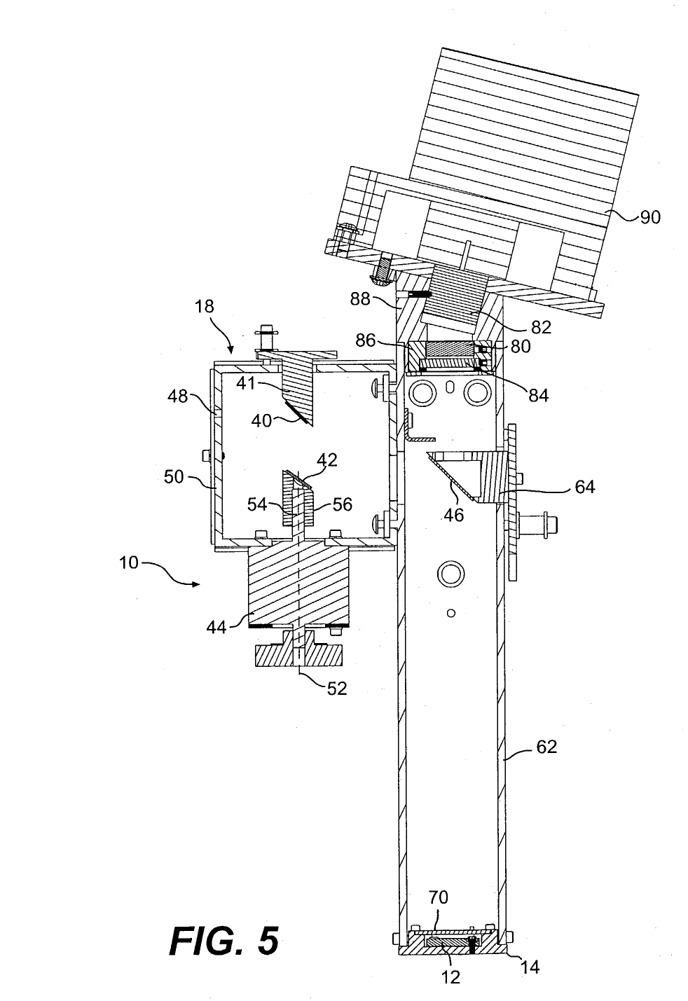

In accordance with various embodiments of the present invention, the scanning system 10 includes an excitation light direction mechanism 18 for directing the excitation light to a single well lens 12 at a time. According to various embodiments shown in FIGS. 1-6, the excitation light direction mechanism 18 includes a stationary mirror 40, a rotating mirror 42, a motor 44 for rotating the rotating mirror 42, and a beam splitter 46. The excitation light direction mechanism is configured so that the excitation light may be intermittently directed at each of the well lenses 12 in a sequential manner. As shown in FIG. 1 and FIG. 5, the stationary mirror 40 reflects the excitation light from the laser 16 to the rotating mirror 42. In various embodiments, the excitation light passes through an aperture 48 in the mirror housing 50 as it travels between the laser 16 and the stationary mirror 40, as shown in FIG. 5. The stationary mirror 40 may be mounted to the mirror housing 50 in any suitable manner and at any suitable angle. In various embodiments, the stationary mirror is mounted on the mirror housing by an adjustable mount 41. In various embodiments, the stationary mirror may be eliminated and the laser 16 may be positioned so that it directs the excitation light directly onto the rotating mirror 42.

According to various embodiments shown in FIGS. 1-5, the rotating mirror 42 is positioned at an angle to the rotational axis 52 of a scan motor 44. The scan motor rotates the rotating mirror about the rotational axis 52. The scan motor 44 is mounted to a bottom of the mirror housing 50 in any suitable manner. The rotating mirror is attached to an output shaft 54 of the scan motor 44 by any suitable manner. In the example shown in FIG. 5, the rotating mirror 42 is positioned on a sleeve 56 that is rotatably fixed to the output shaft 54 of the scan motor. As shown in FIG. 1, the surface of the rotating mirror may be positioned at an angle of forty-five degrees to the rotational axis 52 of the scan motor 44. With the surface of the rotating mirror 42 arranged at a forty-five degree angle, the excitation light beam reflects at an angle of ninety degrees to the rotational axis 52, as shown by the excitation light or energy beam 60 in FIG. 1. The excitation light beam 60 is generated by the excitation light source 16 and includes energy emitted by the source 16. The excitation light beam 60 will maintain the ninety degree angle relative to the incoming beam for every rotational position of the rotating mirror. However, as the rotating mirror is rotated about the rotational axis 52, the reflected excitation beam 60 will move about the rotational axis 52.

In various embodiments, the scan motor rotates to sixteen discrete angular positions, so that each discrete angular position corresponds to a particular well lens. The motor may be a stepper motor that has a limited range of rotation. For example, in various embodiments, a fifteen degree range of rotation causes the excitation light to travel from the first to the sixteenth well lens in a given row. The rotating mirror 42 starts at a first angular position corresponding to the first lens, pauses at this position for a predetermined length of time so that the sample well aligned with the first well lens may be scanned, and then rotates to a second angular position for a predetermined period, and so forth until the excitation light has been directed at all sixteen well lenses. After the sixteenth well lens, the motor rotates the mirror back to the first position corresponding to the first well lens. In various embodiments, the timing of the rotation of the scan motor is coordinated with the speed of translation of the well housing so that the excitation light passes through the correct well lens at the desired time. In other words, the excitation light is directed at the first well position when the first well lens is properly positioned above the first sample well, and the excitation light is directed at the second well position when the second well lens is properly positioned above the second sample well, and so forth.

According to certain embodiments, the scanning system includes a beam splitter 46 that not only reflects the reflected excitation light 60 to the well lens, but also allows the returning emission light to pass through it. As shown in FIG. 5, a beamsplitter can be positioned in a scan housing 62. The beam splitter 46 may be mounted in the scan housing by any suitable method and at any suitable angle. In the example shown in FIG. 5, the beam splitter is attached to the scan housing by an adjustable two-position mount 64. In various embodiments, the beam splitter is a dielectric beam splitter that reflects the incoming excitation light, but permits the emission light to pass through it to the optical detection system 20.

In various embodiments shown in FIGS. 1-5, the reflecting surface of the beam splitter 46 is arranged at a forty-five degree angle to the side of the scan housing 62. The beam splitter reflects the incoming reflected excitation light 60 to the corresponding well lens 12. As shown in FIG. 2, depending on the angle of rotation of the scan motor 44, the reflected light 60 strikes a different position on the beam splitter. The excitation light for each of the positions of the beam splitter corresponds to a different well lens of the well lens housing, as shown in FIG. 2. For example, the position marked x₁ in FIG. 2 corresponds to the position at which the reflected excitation light 60 strikes the beam splitter in order to be reflected to the first well lens position and the first sample well. Likewise, the position marked x₁₆ corresponds to the position at which the reflected excitation light 60 will strike the beam splitter in order to be reflected to the sixteenth well lens position and the sixteen sample well of the row. As can be seen in FIG. 2, the other positions corresponding to the second through fifteenth well lens positions are located between these two points. Each one of these sixteen positions on the beam splitter corresponds to a discrete angular position of the rotating mirror.

In various embodiments, a lens such as fresnel lens 70 is positioned between the beam splitter 46 and the well lenses 12. The fresnel lens 70 is generally configured to change the angle of each incoming excitation light so that the excitation light is centered in the appropriate well lens 12 and sample well 22. The fresnel lens provides a telecentric viewing of the sample wells so that the well lens may focus the excitation light to a small spot on the sample of the sample wells. In various embodiments, the fresnel lens has a focal length of 254 mm. The focal length of the fresnel lens may be varied depending on the specific configuration of the device. The fresnel lens 70 may be mounted in the system, e.g., to the well lens housing 14, in any suitable manner, such as by bolts or other fasteners.

Other types of lenses beside fresnel lenses may be positioned between the beam splitter 46 and the well lenses 12. Instead of a fresnel lens, a standard telecentric objective may be used. A telecentric lens is typically more expensive but may result in a better quality image. Other types of lenses are also suitable.

An aperture (not shown) may also be provided between the fresnel lens and the well lens to reduce stray light and reduce cross talk between the sample wells according to certain embodiments. The aperture may also be used to set the resolution of the optical detection system 20 according to various embodiments. The apertures may be of a variety of geometric shapes including, but not limited to, round, rectangular, and square.

After passing through the fresnel lens, the excitation light passes through a well lens 12 and is focused on the sample in the adjacent sample well. The sample is generally located at approximately the focal distance from the well lens so that the excitation light is directed onto the sample. The light emitted from the sample (emission light) after being struck with the excitation light is collected by the well lens 12. The emission light from the sample that is collected by the well lens 12 is then directed back to the fresnel lens 70 toward the beam splitter 46. The beam splitter is configured so that the emission light from the sample well is permitted to pass through to the optical detection system 20.

In accordance with various embodiments of the present invention, an optical detection system 20 is provided for analyzing emission light from all or each sample well that passes through the beam splitter 46. In accordance with various embodiments, the optical system includes a light separating element such as a light dispersing element. A light dispersing element can be any element that spectrally separates incoming light into its spectral components. For example, incoming light can be deflected at an angle roughly proportional to the wavelength of the light. Thus, different wavelengths are separated. Suitable light dispersing elements include a transmission grating, a reflective grating, or a prism. In a transmission grating, light passes through the grating and is spectrally dispersed, whereas, in a reflective grating, incoming light is reflected off of the grating surface at an angle, without passing through the grating surface. In various embodiments, the light separating element may be a beamsplitter or filter such as a dichroic filter that is used to analyze a single wavelength without spectrally dispersing the incoming light. In a configuration with a single wavelength light processing element, the optical detection device is limited to analyzing a single wavelength, thereby one or more light detectors each having a single detection element may be provided.

For purposes of illustration only, in various embodiments where the light separating element spectrally disperses the incoming light, the light dispersing element will be described as a transmission grating 80, such as shown in FIGS. 1-5. Typically, a grating has hundreds or thousands of grooves per mm. In various embodiments, the grating groove density may range from about 100 grooves/mm to about 1,200 grooves/mm. In certain examples, the grating groove density is approximately 424 grooves/mm.

The light dispersing element spreads the light spectrally in a direction substantially perpendicular to spectral channels on the light detection device. This configuration creates a two-dimensional image on the light detection device after the light passes through a lens element 82. The lens element may be any type of suitable lens, such as a camera lens, which focuses the light onto a light detection device. In various embodiments, the lens element 82 is a multi-element camera lens with a focal length of about 24.5 mm and an aperture speed of about 1.6.

The optical system may further include one or more blocking filters to prevent significant amounts of excitation light or other background light (from other sources) from reaching the light detection device. In various embodiments, one or more blocking filters, such as long-pass filters, may be provided in the optical path of the emission light. FIGS. 1-5 show an excitation blocking filter 84 positioned between the beam splitter 46 and the transmission grating 80. The filter 84 may be configured to allow any suitable range of wavelengths to pass through it and to block wavelengths outside that range from passing through it. In certain examples, the blocking filter permits light having a range of approximately 510 to 650 nm to be transmitted through it. Other types of filters may also be used throughout the scanning system. In the example shown in FIG. 5, the blocking filter 84 and transmission grating 80 are arranged in a housing 86 at the top of the scan housing 62. The lens element 82 is positioned in a lens housing 88 adjacent the housing 86 as shown in FIG. 5.

In various embodiments, the optical detection system may further include a light detection device 90 for analyzing light from a sample for its spectral components. In various embodiments, the light detection device 90 comprises a multi-element photodetector. Exemplary multi-element photodetectors may include, for example, charge-coupled devices (CCDs), diode arrays, photo-multiplier tube arrays, charge-injection devices (CIDs), CMOS detectors, and avalanche photodiodes. In various embodiments, the light detection device may be a single element detector. With a single element detector, a single sample well may be read at a time. A single element detector may be used in combination with a filter wheel to take a reading for a single sample well at a time. With a filter wheel, the sample well tray typically is scanned a large number of times, each time with a different filter. Alternately, other types of single dimensional detectors are one-dimensional line scan CCDs, and single photo-multiplier tubes, where the single dimension could be used for either spatial or spectral separation. It will be understood that alternatively, several single dimension detectors could be used in combination with a dichroic beam splitter.

The light or energy detected by the light detection system 90 may be selected from a range to ensure proper detection of the emitted beam. Specifically, several dyes or probes may be placed in a sample or the sample itself may react to the excitation beam. The reaction or response to the beam emits a plurality of photons which can be detected by the light detection system 90. Generally, the light detection system 90 selectively detects photons in a selected wavelength range. For example, the light detection system 90 may be selected to detect light within a particular wavelength having a full width half max of any appropriate length. Generally, the length may be between about 20 and about 40 nanometers. Therefore, the light detection system 90 may not detect only one particular wavelength, but rather a range of wavelengths to properly detect the excitation beam. The wavelengths may be any appropriate wavelengths that are emitted by the probes or sample.

Therefore, the wavelengths may vary anywhere along the spectrum. It will also be understood that appropriate light detection systems can be provided that detect non-visible wavelengths. For example, infrared and ultraviolet wavelengths may be detected that are emitted by the sample, probes, or dyes. Nevertheless, the light detection system 90 may be provided such that a range of wavelengths are detected and accepted as a positive emission from the selected probe.

According to various embodiments of the present invention used with a light dispersing element, a CCD is typically used to view all of the wells of a row. In the embodiment described above, the CCD obtains a thirty-two point spectrum for each of the sixteen wells of a row. The spectrum is formed on a surface of the CCD camera and analyzed for its spectral components. In various embodiments, the CCD element is thermally cooled and has an array of 64 by 512 pixels, and a resolution of 0.027 mm. In a typical operation, the spectrum for each sample is read after the entire row of wells has been scanned.

Methods of scanning a sample well tray having a plurality of samples positioned in sample wells are apparent from the description of the various embodiments of the scanning system above. The methods include generating an excitation light with an excitation light source. As discussed for certain examples, a laser 16 may generate an excitation light. The method further includes directing the excitation light to a first well lens in a row of well lenses, as shown, for example in FIG. 7A.

In various examples, directing the excitation light to the well lens includes reflecting the excitation light against a mirror, and rotating the mirror to discrete positions so that the reflected excitation light is directed at a corresponding well lens. In various embodiments, the excitation light is directed against a rotating mirror 42 that is sequentially rotated to sixteen discrete angular positions about a rotational axis 52. The rotating mirror 42 is angled relative to the rotational axis so that each of the discrete angular positions corresponds to a particular well lens 12 of the well lens housing. In various embodiments, the light from the rotating mirror 42 is reflected off of a beam splitter 46 toward a corresponding well lens. In various embodiments, the row of well lenses is angularly offset relative to an adjacent row of sample wells.

The method may further include illuminating a sample in a first sample well of the row of sample wells positioned adjacent the row of well lenses with the excitation light to generate an emission light. The sample is caused to fluoresce by the excitation source so that it emits an emission light.

The method may further include optically detecting the optical characteristics of the emission light from the sample well. In certain examples, the emission light from the sample well passes through the same sample well as the excitation light had previously passed through on its way to the sample well. The emission light is directed toward an optical detection system, such as optical detection system 20. In various embodiments, the step of optically detecting the spectral characteristics of the emission light includes spectrally dispersing the emission light with a light dispersing element, such as a transmission grating, which spectrally disperses the emission light. The dispersed light from the light dispersing element is then directed onto a light detection device by a lens element. The light detection device, for example, a CCD detects the spectral characteristics of the emission light. The spectral characteristics may then be analyzed by any methods or devices. In various embodiments, the light is not spectrally dispersed but is separated by a light separating element such as a filter. It will be understood that alternatively, several single dimension detectors could be used in combination with a dichroic beam splitter.

After scanning a first sample well, according to various embodiments, the method further includes directing the excitation light to a second well lens positioned adjacent the first well lens of the row of well lenses. The excitation light illuminates a sample in a second sample well of the row of sample wells with the excitation light to generate another emission light. The sample of the second sample well is caused to fluoresce by the excitation source so that it emits an emission light. In various embodiments, the rotating mirror 42 rotates to a second angular position so that the excitation light is directed to the second well lens, as shown for example in FIG. 7B. At the time the excitation light is directed at the second well lens, the row of well lenses has translated in a direction perpendicular to the row of sample wells at a substantially uniform speed (in the “x” direction as labeled in FIG. 7A). At the position shown in FIG. 7B, the second well lens is aligned with a second well of the first row of sample wells.

The spectral characteristics of the emission light from the second sample well may then be optically detected in the same manner as described above for the first sample well. Throughout the above method, the row of well lenses and sample tray are moved relative to one another. In certain configurations, the row of well lenses linear translates relative to a stationary sample tray. In certain other configurations, the sample tray linearly translates relative to a stationary row of well lenses.

The method may further include optically detecting the spectral characteristics of the emission light from the remaining sample wells in the row as the well lenses continue to translate in the perpendicular direction. After the last sample well of the row (see FIG. 7D) has been optically detected, the light detection device takes a reading of the spectral characteristics of the entire row. The well housing 14 continues to translate in the x-direction (see FIG. 7E) so that the first well lens of the row of well lenses is eventually aligned with the first sample well of the second row of sample wells, as shown in FIG. 7F. At this position, the excitation light direction mechanism directs the excitation light to the first well lens so that the aligned sample well may be illuminated and optically detected. The procedure continues until the entire sample tray has been scanned.

The method may also comprise other procedures such as blocking a portion of light having a wavelength lower or higher than a selected wavelength using a blocking filter. Other methods suitable with the scanning system described above may also be used.

According to various embodiments, described above, and exemplary illustrated in FIG. 2 a single light source 16 is reflected off of the stationary mirror 40 and again reflected off the rotating mirror 42. The rotating mirror 42 allows the single light source to be reflected along a plurality of paths to excite samples in a plurality of sample wells 22. Nevertheless, only a single light beam is produced that must be translated amongst the various sample wells.

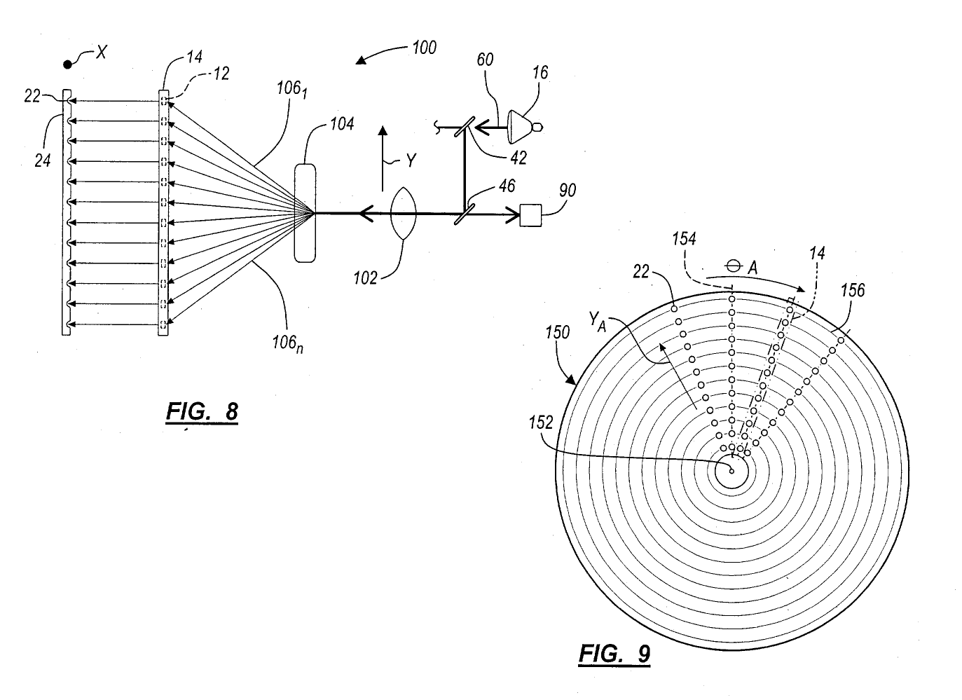

A detection system 100 illustrated in FIG. 8, uses the excitation light source 16 to produce the single light or excitation beam 60 which may be reflected with the rotating mirror 42, or may be directed in a direct path depending upon the mechanism into which it is installed. A focusing element, such as a lens 102, may be used to focus the single light beam 60, from the beam splitter if desired, it will also be understood that various embodiments may not use a focusing lens 102.

The single excitation light beam 60 is directed through an optical dividing element 104 that acts as a diffuser or divider. According to various embodiments, the dividing element 104 divides the single excitation light beam into many light beams, as noted below. Various dividing elements may be used for example, the optical element may include a holographic diffuser, beam splitter, or a fish-eye lens array. Therefore, the optical element will not be understood to be limited to a specific embodiment, but include any appropriate system. The dividing element 104 separates the single light beam 60 into a plurality of light beams 106₁-106ₙ. The integer n may be any number depending upon the number of sample wells 22 formed in the sample tray 24.

The plurality of light beams 106₁-106ₙ may be focused with the plurality of well lenses 12, held in the well lens housing 14. The well lenses 12 focus the plurality of light beams 106₁-106ₙ onto the plurality of sample wells 22. Alternatively, one lens may be used to focus all of the beams 106a-106n simultaneously onto a plurality of the sample wells 22. In this way, each of the plurality of wells 22 in a single column can be simultaneously illuminated with the excitation light beams 106₁-106ₙ.

It will be understood that the example illustrated in FIG. 8 may be incorporated into the other various embodiments such that the beam splitter 46, as shown in FIG. 2, can be used to split the beam and allow reflected or emitted excitation light to be read by the optical reader or light sensor 90, also shown in FIG. 2. Nevertheless, according to the embodiment illustrated in FIG. 8, during use the sample well tray 24 can be moved in a direction X, in FIG. 8 into the page, allowing each of the sample wells 22 in a column to be excited and optically read simultaneously. That is the tray 24, the lens housing 14, or other portion of the system 100 moves relative to another portion to selectively align the various excitation beams 106₁-106ₙ with a selected number of the sample wells 22. As illustrated in FIG. 8, the tray 24 moves in direction X to selectively align the sample wells 22 to the excitation beams 106₁-106ₙ. According to various embodiments, other portions move to selectively align the sample wells 22 and the excitation beams 106₁-106ₙ. According to the embodiment illustrated in FIG. 8, rather than exciting and reading a single well at a time, a plurality of wells are excited and read at a single time. In various embodiments, the detection system 100 may translate relative to the sample well tray 24 along a direction X. In various other embodiments, the sample well tray 24 or the detection system 100 may be translated in a direction Y wherein the detection system will excite and optically read a plurality of the sample wells 22 in columns.

Any appropriate system may be used to separate a single light beam into a plurality of excitation beams 106₁-106ₙ. One exemplary system is described in commonly assigned U.S. patent application Ser. No. 09/964,778 entitled, “Shaped Illumination and Geometry and Intensity Using a Defractive Optical Element,” incorporated herein by reference for all purposes. The dividing element 104 may include a hologram or a diffractive grading. It will be understood, however, that the specific embodiment of the dividing element 104 is not particularly relevant to the application of the system 100. Simply, the dividing element 104 splits the single excitation light beam 60 into the plurality of excitation beams 106₁-106ₙ to excite a plurality of the sample wells 22 at a given moment in time. In turn, this allows the samples placed in the same plurality of sample wells to create emission light simultaneously such that they can be read substantially simultaneously.

According to various embodiments, a system to optically read a plurality of sample trays may exemplarily be used with a rotating array. Specifically, a rotating array may be formed by placing an array on a circular disk and rotating it to allow particular sample areas on the circular disk to be excited and an excitation beam produced to be read by an optical reader. The disk array may rotate allowing various sample areas to be excited within an excited illumination beam as each sample area rotates past a specific point. Alternatively, an excitation beam may move relative to the disk to excite various sample areas on the disk. The sample tray or disk may be formed to any particular shape depending upon the specific apparatus. For example, the disk may be formed as a circle or a polygon. Generally, however, the sample disk or platform will have an axis of rotation about which the sample platform may rotate. The axis of rotation may be fixed or moveable depending upon the specific apparatus.

In various embodiments, the sample areas may be sample wells which hold a sample including a marker which may be excited by a certain wavelength of energy. Various wavelengths may be used in various embodiments including infrared, visible, and ultraviolet wavelengths. These wavelengths may be provided from any number of light sources, as described above, and may exemplarily include laser beams of various sorts, incandescent lamps, organic light emitting diodes, light emitting diodes, or fluorescent lamps. Nevertheless, in addition to the exemplarily rectangular arrays discussed above, various embodiments include arrays placed on disks which allow the disk to rotate relative the excitation beam or the excitation beam to move relative the disk, or both move relative to each other.

Sample wells may be placed on a sample platform in a plurality of orientations. In one example, illustrated in FIG. 9, a sample well disk 150 includes a plurality of the sample wells 22. The sample well disk 150 includes a center 152 which defines an axis for rotation for the sample well disk 150. Spaced radially on the disk, along a plurality of radiuses defined by the disk 150, are the plurality of sample wells 22. Generally, a number of the sample wells 22 are spaced radially and laterally apart along a single radius 154. Although it will be understood that the disk 150 may include a plurality of the radiuses 154 and each may include a plurality of the sample wells 22, only a small number of radiuses and sample wells are illustrated for clarity. Specifically, as illustrated in FIG. 9, the plurality of the sample wells 22 are placed on a plurality of concentric circles 156 which are rings defined through the center of a selected group of the sample wells 22.

With continuing reference to FIG. 9, the focusing element such as the well lens housing 14, shown in phantom, may be positioned relative the sample well disk 150 to direct the excitation beam and the emitted light from the samples in the sample wells 22. The sample wells 22 that are aligned on a radius 154 each become selectively aligned with the well lens housing 14 at substantially the same time. Therefore, each of the sample wells 22 placed on the radius 154 aligned with the well end housing 14 can be excited and detected simultaneously. This will allow sample wells 22 to be read simultaneously or nearly simultaneously without moving the sample well disk 150. In particular, when the well lens housing 14 is aligned with a plurality of the sample wells 22 a diffuser, such as the dividing element 104 illustrated in FIG. 8, may be used to excite all of the sample wells 22 aligned with the well lens housing 14. This can be helpful in various embodiments where the sample placed in the sample well 22 requires a long excitation to react properly.

The sample well disk 150 can be rotated in any direction, but is generally moved or rotated along an angle of rotation θₐ. The rate of rotation will depend upon the apparatus upon which the sample disk 150 is placed. Any commonly used sample apparatus may be used to rotate the sample well disk 150 in a desired rate or direction. It will be understood, however, that the speed and direction of the angle θₐ may be dependent upon the excitation beam apparatus and the optical reading apparatus. Although the sample well disk 150 may be placed on any appropriate mechanism to excite and read the samples from the sample wells 22, according to the various embodiments, the sample well disk 150 may be used in conjunction with the previously described apparatus, as illustrated in FIG. 5.

The above-described apparatuses can easily be modified to allow a rotational moment for the sample well disk 150 rather than a linear translation of the sample well tray. Nevertheless, the system generally includes a platform to hold the sample well disk relative to the excitation beam and the light detection mechanism 90. As described above, the excitation beam may move relative the sample wells or the sample well disk 150 may be rotated relative a stationary excitation beam or both. In addition, axis of rotation 152 need not necessarily be placed in the center of the disc 150. Generally, as the sample disc 150 rotates portions of the sample wells 22 become aligned with the well lens housing 14 or with the excitation beam transmitted through the well lens housing 14. According to various embodiments, the well lens housing 14 or the excitation source 16 (illustrated in FIG. 1) may be moved to align selected of the sample wells 22 with the excitation beams. Moreover, the sample well disk 150 or excitation beam may be moved then held motionless for a time to align selected sample wells 22 with the excitation beam 60.

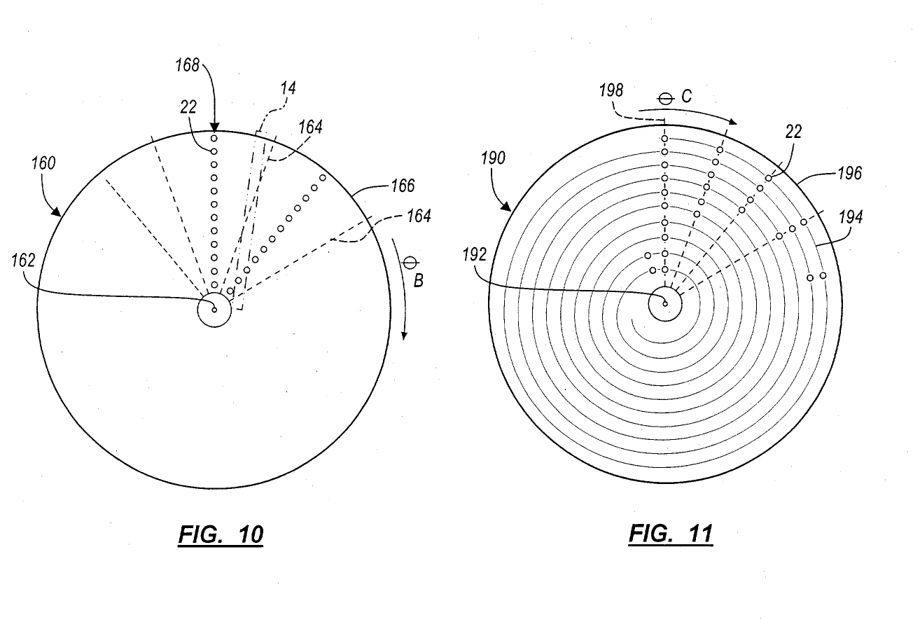

Alternatively, a sample well disk 160, illustrated in FIG. 10, includes an axis of rotation 162 to allow it to rotate in a direction θ_{b}. It will be understood, that the direction θ_{b} may include any rotational direction relative to the sample well disk 160. Moreover, an angular rotation rate may be selected at any rate appropriate for the particular excitation and emitted beams. The sample well disk 160 includes a plurality of radii 164 which extend from the axis of rotation 162 to an edge 166 of the sample well disk 160. A plurality of sample wells 22 may be formed into or onto the sample well disk 160. The sample wells 22 may be formed in any appropriate manner, such as those discussed above.

A well lens housing 14 may be oriented relative the sample well disk 160 such that the well lens housing 14 does not ever become oriented with any of the radius 164 of the disk 160. In this case, as the disk 160 rotates in the direction θ_{b}, only one of the sample wells 22 becomes selectively aligned with the well lens housing 14 at a given moment in time. Although not particularly illustrated, in FIG. 10, the well lens housing 14 includes a plurality of well lenses. Since the well lens housing 14 is never aligned with the radius 164 of the disk 160, only one well lens will be aligned with one of the sample wells 22 at a given time. Therefore, as the sample well disk 160 rotates a succession of the sample wells 22 become selectively aligned with the well lens housing 14. Alternatively, lenses in the housing 14 may be placed in a non-colinear manner. When the lens of the well lens housing are non-colinear, the lenses may be selectively and differently offset from a selected axis to vary the alignment of the lens in the system.

As described above, each of the plurality of sample wells will pass through a selected plane defined by the well lens housing 14 at a selected and predetermined point. In addition, only one sample well is present in this plane at a given time. Specifically, only one of the sample wells 22 will be excited and detected at any given time within this specific plane. Because only one sample well 22 is aligned with a lens 12 in the well lens housing 14 at any given time only one excitation beam is necessary. Therefore, the configuration exemplary illustrated in FIG. 10 can be used with various apparatus exemplary described herein, specifically a rotating mirror 42.

A sample well disk 190, illustrated in FIG. 11, includes an axis of rotation 192 which allows the sample well disk 190 to move in a direction θ_{c}. It will be understood, that the direction of θ_{c} may be any appropriate direction depending upon various other portions of the detection apparatus associated with the sample well disk 190. Formed on the sample well disk 190 are a plurality of sample wells 22. The plurality of sample wells 22 may be formed in any appropriate manner, such as those described above.

The plurality of sample wells 22 on the disk 190 define a radially collapsing spiral 194 from a periphery 196 to the axis of rotation 192. Each succeeding sample well 22 on the sample well disk 190 has a center closer to the axis of rotation 192 than the preceding sample well. This defines an internally collapsing spiral, such as a spiral defined on a vinyl record or the optical tracks defined on a commonly known compact disk. Therefore, drawing a continuous line through the center of each of the plurality of sample wells 22 will define the internally collapsing spiral 194. Nevertheless, a radially extending group of the sample wells 22 are all set on a selected radius 198 of the disk 192.

The sample well disk 190 can be used in a plurality of mechanisms. Specifically, because the sample wells 22 are placed on an internally collapsing spiral 194, a single moving lens, which follows the internally collapsing spiral 194, can be used with the sample well disk 190 as the disk continuously rotates. Nevertheless, because the sample wells 22 are placed on a plurality of radii 198, the well lens housing 14 can be used and selectively aligned with a selected plurality of the sample wells 22, such as that illustrated in FIG. 9. Alternatively, the well lens housing 14 may be individually selectively aligned with one of the sample wells 22 at a time, such as illustrated in FIG. 10. In addition, a plurality of the sample wells 22 can be excited at a given time using the optical divider 104, such as that illustrated in FIG. 8. Regardless, the sample wells 22 placed on the sample well disk 190 are selectively aligned with the excitation beam. As described above, the disk 190, the excitation beam, focusing element, or a combination may be moved to selectively align the sample well 22 and the excitation beam.

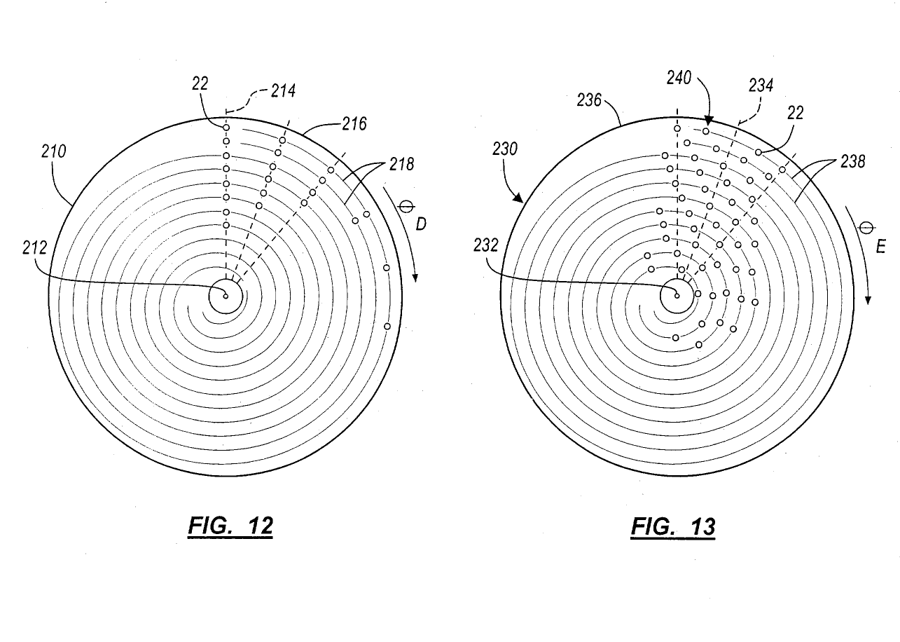

A sample well disk 210, illustrated in FIG. 12, generally includes an axis of rotation 212 and a plurality of radii 214 defined between the axis of rotation 212 and a periphery 216 of the sample disk 210. Formed on the sample well disk 210 are a plurality of sample wells 22. The sample wells 22 may be formed on the sample well disk 210 using any appropriate method such as those described above. The sample wells 22 define a plurality of internally collapsing spirals 218 on the sample well disk 210. Rather than one continuous line of the sample wells, a plurality of the internally collapsing spirals 218 are defined through separate groups of the sample wells 22. Therefore, more than one internally collapsing spiral track 218 is formed on the sample well disk 210 thereby allowing more than one track to be followed from the periphery 216 to the axis of rotation 212. Although described and illustrated as being in the center of the disk 210, it will be understood that the axis of rotation 212 may be positioned at other positions on the disk 210.

Each sample well 22 has a center which is spaced radially closer to the axis of rotation 212 for each succeeding well. In addition, there are a plurality of the spirals 218 formed by a plurality of sets of the sample wells. Therefore, rather than providing a single internally collapsing spiral, such as that illustrated in FIG. 11, a plurality of the internally collapsing spirals 218 are formed. It will be understood, that any number of these spirals 218 may be formed on the single sample disk 210. Simply, an appropriate number of spirals will be formed depending upon the excitation beam apparatus and the reflected excitation or emitted beam detector.

The sample well disk 210 includes a plurality of internally collapsing spirals 218. Therefore, a plurality of floating lenses (414 in FIG. 15a), described more fully herein, can be used as the focusing element of a system using the disk 210. The focusing element 414 assists to selectively align the excitation beam with the plurality of the sample wells 22. It will be understood that alternative lens configurations may be used, such as the lens housing 14 above-described. Specifically, a plurality of lenses can follow a plurality of the internally collapsing spirals 218 to assist in selectively aligning the excitation beams to complete excitation and detection of the samples on the sample well disk 210 in an efficient manner. In addition, because a selected plurality of the sample wells 22 are placed on the radii 214, a selected plurality of the sample wells 22 can be excited and detected at a given time. As discussed above and herein, multiple excitation beams may be produced with a diffuser 104 (FIG. 8).

With reference to FIG. 13, a sample well disk 230 includes an axis of rotation 232 and a plurality of radii 234 between the axis of rotation 232 and a periphery 236 of the sample disk 230. A plurality of sample wells 22 may be formed on the disk 230 using any appropriate method, such as those described above. The plurality of sample wells define a plurality of internally collapsing spirals 238, where each of the plurality of sample wells includes a center which is offset towards the axis of rotation for each succeeding sample well. Therefore, when the sample well disk 230 is rotated in a direction θₑ, the internally collapsing spiral 238 is defined by each succeeding center of each of the plurality of sample wells.

Each of the sample wells 22 placed on the sample disk 230 may be spaced an equal or selected θ distance apart. In this case, rather than all of a set of sample wells extending radially from the axis of rotation 232 being on a single radius 234, different groups of the radially extending sample wells may lie on a different radius. Therefore, a large plurality of the sample wells 22 may be placed on the sample well disk 230. Maintaining a constant θ allows constant θ velocity. It will be understood, however, that variable θ may also be used which allows for tighter spacing, thereby requiring that the lens must compensate for variations in relative velocity. It will be further understood that any appropriate mechanism may be used to selectively align the sample wells 22 formed on the disk 230 with the excitation beam.

Although the sample well disk 230, and each of the sample well disks described above, can be formed in a plurality of sizes generally the sample well disk 230 may have a diameter of between about 5 cm and about 31 cm (about 2 inches and about 12 inches). Larger sizes allow for a greater number of samples per disk. For example, a 31 cm diameter disc may be used to scan an entire genome at once. In addition, the sample wells 22 can be formed in any appropriate size and spaced apart appropriately. It will be understood that the sample wells 22 may be placed a specific distance apart depending upon the type of sample or detector being used. Nevertheless, the sample wells are generally placed between about 0.1 mm and about 1.0 cm apart. The total number of sample wells 22 placed on the exemplary sample well disk 230 or the other well disks is generally between about 1,000 and about 10,000.

It will be understood that a variety of orientations other than those specifically described may also be used. For example, the sample wells 22 may be formed on a disc such that they are spaced an equal distance from one another. That is that the arc defining the distance between any two adjacent wells is substantially equal. In this embodiment, it will be understood that the excitation beams and detection apparatus must account for the variance is angular speed if the rotation of the disc is kept constant throughout the use of the disc. Alternatively the sample wells 22 defined on a disc may be placed at variable distances apart. Therefore, the various wheels may be placed at any selected distance around the disc. Regardless of the specific orientation it will be understood that the sample wells 22 may be formed on a disc in any selected pattern as long as the excitation and detection apparatus is oriented to properly read the sample placed in the sample wells.

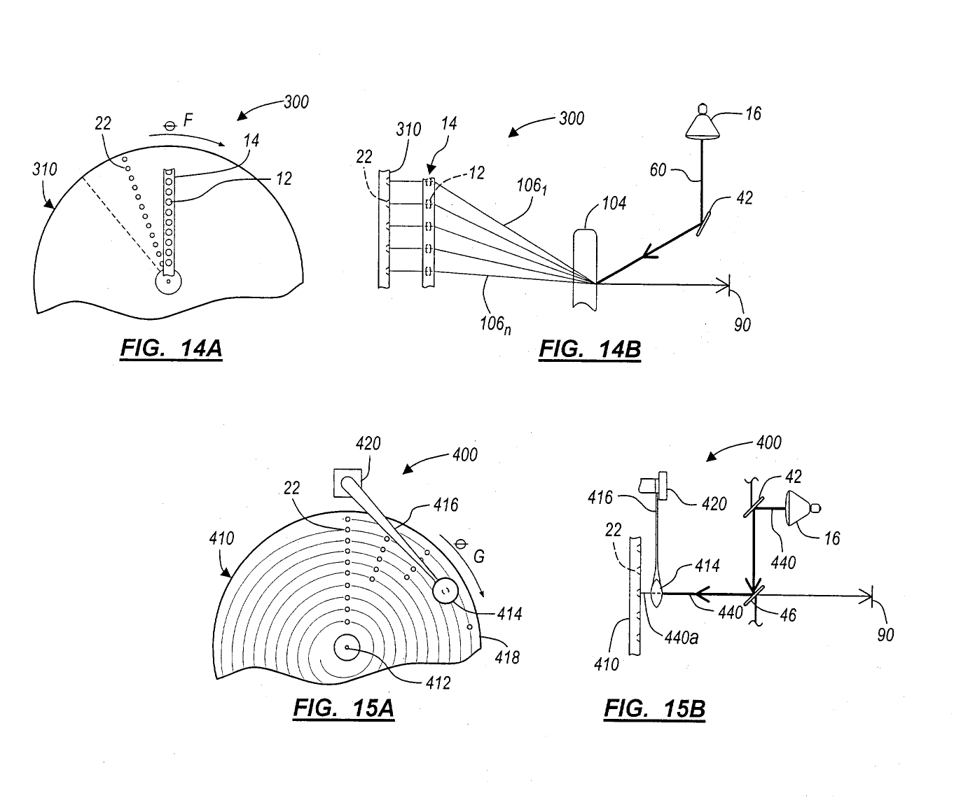

Turning to FIGS. 14a and 14b, methods of operating the detection system, includes placing the well lens housing 14 having a plurality of the well lenses 12 which focus an excitation beam onto one of the plurality of sample wells 22 as discussed. In the detection apparatus 100, any number of the above-described various embodiments of sample well disks may be used. The following description may be used with any number of the plurality of sample well disks, but may also be used with the examples illustrated in FIG. 9 and FIG. 10. Specifically, either the well lens housing 14 may translate relative about an axis to the sample well disk 310 or the sample well disk 310 may have an angle of rotation θ_{f}. Alternatively, both the sample well disk 310 and the well lens housing 14 may move simultaneously or relative one another in both θ and linear motion. Other specific elements of the various embodiments are described above.

The light source 16 is used to produce the excitation beam 60 which is reflected off a fixed or rotating mirror 42. It will be understood that other lenses or gratings may be used to further direct, focus or limit the spectral range of the excitation beam 60. The mirror 42 may be a fixed mirror to simply orient the excitation beams 60 to the diffuser 104. This may be necessary to create the most efficient apparatus to excite and detect the samples placed in the sample wells 22. Alternatively, specifically if the diffuser 104 is not used, the mirror 42 may be the rotating mirror 42. This moves the excitation beam 60 between each of the plurality of the well lenses 12 in the well lens housing 14 to excite each of the sample wells 22 consecutively. Therefore, either a rotating mirror, fixed mirror, or both may be used depending upon the other selected portions of the detection system 300. In addition, a light detector or sensor 90 detects the emitted beam or emitted signal from the sample placed in the sample wells 22. It will also be understood that additional lenses or mirrors may be used to reflect or direct the emitted beam to the detector 90.

According to the various embodiments, the well lens housing 14 may define or become aligned with a radius of the sample well disk 310. The sample wells 22 may be formed on the sample well disk 310 such that a plurality of sample wells 22 will be aligned with an adjacent well lens 12 at a given period of time such as that exemplarily illustrated in FIG. 9. Alternatively, the sample wells 22 may be positioned on the sample well disk 310 such that only one of the sample wells are adjacent a sample well lens 12 at a given period of time. In addition, as described above, the rotating mirror 42 may reflect the beam of excitation light from the light source 16 to each of the sample well lenses 12 to excite the sample placed in the sample well 22. This occurs regardless whether a plurality of sample wells are aligned with the well lens housing 14 or if only one of the sample wells is aligned with the well lens housing 14. It will be understood that if the excitation beam 60 is an appropriate excitation beam, a well lens 12 may not be necessary to properly focus the excitation beam onto any of the selected sample wells 22. For example, a finely focused laser may be translated amongst the plurality of the sample wells 22, either by moving the laser or using the rotating mirror 42, to excite the sample in the sample wells 22 without the additional assistance of a well lens 12.

According to various embodiments, when a plurality of the sample wells 22 are adjacent the well lens housing 14, the sample well disk 310 is stopped while the single beam of light is transmitted separately through each of the well lenses 12 in the well lens housing 14. After the excitation beam has excited the sample in a given one of the sample wells 22, the excitation beam will be translated to the next sample well. It will be understood that the excitation light beam may be moved sequentially or moved in any pattern amongst the various sample wells. After a sample in a given sample well 22 is excited, a reflected excitation or emitted beam is produced which may be read by the optical detector or reader 90. It will be understood that various lenses 82 or blocking filters 84, as described in various other embodiments and illustrated in FIG. 2 may also be used in various embodiments to limit the amount or type of energy reaching the optical reader 90.

According to various embodiments, and discussed further herein, a diffuser 104 may be used to create a plurality of excitation beams to be directed at each of the well lenses 12 and the well lens housing 14 at once. In such a manner, each of the sample wells 22 aligned with a well lens 12 may be excited simultaneously. Therefore, rather than providing the rotating mirror 42 to direct the single excitation beam 60 to each of the plurality of well lenses 12, the diffuser 104 is used to produce a plurality of excitation beams. Alternatively, the rotating or a fixed mirror may be used to direct the excitation beam 60 to the diffuser.

According to various embodiments, when the sample wells are offset from a specific radius on the sample well disk 310, such as the sample wells illustrated in FIG. 11, the sample well disk 310 may move continuously in the direction θ_{f}. In this case, only a single one of the sample wells 22 is adjacent or aligned with a given well lens 12. Therefore, the excitation beam provided by the light source 16 can be reflected with the rotating mirror 42 to direct the excitation beam to a given well lens 12 to excite a specific one of the sample wells 22. This sample well can then produce the emitted beam which can be read by the light sensor 90. As the sample well disk 310 continues to rotate in direction θ_{f}, the rotating mirror 42 can move the excitation beam to a different one of the sample wells as a different sample well becomes aligned with a separate well lens. In turn, the emitted beam from that next sample well can produce a reflected excitation beam which can be read by the optical reader 90.

As discussed above, when the sample wells 22 or the well lens housing 14 are offset from a radius of the sample well disk 310, the offset can be selected depending upon the reading speed of the optical detector 90, the concentration of the sample in the sample well 22, or the speed of rotation in direction θ_{f}. Therefore, the offset can be selected to be any specific offset and the rate of rotation can be selected to be any appropriate rate of rotation. Nevertheless, it allows for a substantially continuous excitation and detecting of the samples placed in the sample wells 22 on the sample well disk 310.

According to various embodiments, the well lens 12 and well lens housing 14 may be similar to that described above, and exemplary illustrated in FIG. 5. In addition, the optical reader 90 along with the other components, such as the light source 16 may be oriented in such a stage such as that illustrated in FIG. 5. It will be understood, however, that various other orientations of the lens housing 14 to the optical reader 90 and the light source 16 may be used. Specifically, various other fixed mirrors and rotating mirrors may move the excitation beam and the emitted beam to various apparatuses depending upon the specific design. It will be understood that the specific design will not limit the scope of the appended claims.

According to various embodiments, a single light ray or beam 60 may be split into a plurality of light beams to be applied to a plurality of the sample wells 22 simultaneously. With references FIGS. 8, 14a, and 14b, the single light beam 60 may engage a diffuser 104 to produce a plurality of excitation beams 106₁-106ₙ. Again, the integer n may be any number or the number of sample wells to be excited simultaneously. Therefore, n may be any appropriate number depending upon the particular apparatus. Moreover, the diffuser 104 may be any appropriate diffuser which will split the single excitation beam 60 into the plurality of excitation beams 106₁-106ₙ. As described above, examples include holograms, gratings, and prisms. Gratings and prisms were used for spectral separation, holographic diffusers, beam splitters, and flys eye lens arrays are used for splitting the excitation beam.

The plurality of excitation beams 106₁-106ₙ are directed towards the plurality of well lenses 12 which are held in the well lens housing 14. Each of the plurality of excitation beams 106₁-106ₙ are focused through one of the plurality of the well lenses held in the well lens housing 14 to excite a sample in one of the plurality of sample wells 22. According to various embodiments, as the sample well disk 310 rotates, the well lens housing becomes aligned with a plurality of the sample wells 22. At this point one of the well lenses 12 is adjacent or aligned with the sample well 22. Therefore, the excitation beam can be focused on the adjacent sample well and the sample excited with one of the excitation beams. Therefore, more than one sample well can be excited with only a single source excitation source beam 60.

A plurality of the sample wells 22 can be placed concentrically on the sample well disk 310. Various embodiments also provide a plurality of sample Wells which are placed concentrically, but on internally collapsing spirals, such as that exemplarily illustrated in FIG. 12. Therefore, as the sample well disk 310 rotates in the direction of θ_{f}, each time the well lens housing 14 is aligned with the plurality of sample wells 22, they may be excited by the split excitation beams 106₁-106ₙ. Again, it will be understood that the beams splitter 46 may be placed on the reflected excitation beam path to direct the reflected excitation beam to a light detector 90. Therefore, the plurality of sample wells 22 can be excited and read at a single time rather than individually. It will also be understood that the sample well lens housing 14 need not extend the entire distance from the periphery to the center of the sample well disk 310. Rather, the well lens housing 14 may simply extend a portion of the way and follow the path of the internally collapsing spiral as the sample well disk 310 rotates.

A sample excitation and detection system 400 may include a sample disk 410 which includes a plurality of sample wells 22 extending radially from a center of rotation 412, as exemplary illustrated in FIGS. 15a and 15b. The sample wells 22 may be placed on the sample well disk 410 according to various embodiments, such as those exemplarily illustrated above. For example, the plurality of sample wells may be placed in concentric rings radiating outwardly from the axis of rotation 412. Alternatively, various embodiments may include sample wells placed on interiorly collapsing spirals such that a center of each of the sample wells is radially offset from a preceding or succeeding sample well. If multiple sample wells 22 are imaged at a time then the placement of the wells with respect to the radii will need to change as the lens moves through its axis of rotation 412. Specifically, as the lens 414 moves relative the radius of the disk 410 and images more than one sample well 22 the wells 22 must be placed on the disc 410 to compensate for the changed orientation of the lens 414 relative the multiple sample wells 22 being imaged.

In various embodiments, the detection system 400 generally includes a floating or translatable objective or well lens 414. The well lens 414 may be moved or operated by the detection system 400 with a lens moving device in a plurality of manners. For example, the objective lens 414 may be held on a needle or arm 416 which allows the well lens 414 to move from the axis of rotation 412 to a periphery 418 of the sample well disk 410. The well lens arm 416 is moved by a motor 420 which can provide either smooth or stepped motion of the well lens 414. According to various embodiments, the motor 420 may move the well lens 414 substantially constantly from either the periphery to the axis of rotation 412 or from the axis of rotation to the periphery 418 as the sample well disk 410 rotates in a direction θ_{g}.

When the sample wells are placed in an internally collapsing spiral the motor 420 moves the well lens 414 through the arm 416 in a substantially continuous manner to move it adjacent to each succeeding sample well as the sample well disk 410 rotates. Therefore, an excitation beam 440 can be focused to form a focused excitation beam 440a directed at one of the selected sample wells 22. The motor 420 may also move the well lens 414 in a step-like manner between each concentric row of the sample wells 22. Therefore, the sample well lens 414 may be moved to one of the concentric rings and the sample well disk 410 may make one full rotation in the direction θ_{g} while the excitation beam 440 excites each of the successive sample wells in that concentric ring. The lens 414 may move in an arc, as illustrated, or in a linear motion relative the disc 410. For example, the lens 414 may be placed on a rail and moved linearly between the edge 418 and the center 412 of the disc 410. The lens 414 allows the excitation beam to be focused on a selected one or plurality of the sample wells 22.

The detection system 400 includes a light or excitation beam source 16 to produce the excitation beam 440. In addition, the rotating mirror 42 may be used to move the excitation beam 440 in conjunction with the well lens 414 so that the excitation beam 440 is focused incident to a particular sample well. Therefore, as the well lens 414 moves between the plurality of the sample wells 22 and becomes aligned with a selected one of the sample wells 22, the excitation beam 440 is focused on that sample well 22 to allow the sample well to be illuminated with the excitation beam. Moreover, according to various embodiments, as discussed above, the beam splitter 46 may be used to direct the emitted beam to the optical or light detector 90.

According to various embodiments, the well lens 414 may “float” relative to the sample well disk 410. Specifically, as the sample well disk 410 rotates in the direction of θ_{g}, a convection current is created around the sample well disk 410. This creates an air pressure differential between the surface of the sample well disk 410 and the air surrounding the sample well disk. Due to this pressure differential, the well lens 414 may be pushed away from the surface of the sample well disk 410, thus allowing the well lens 414 to float above the sample well disk 410. When this occurs, the motor 420 simply moves the well lens 414 along a pre-selected path. Rather than the arm 416 being necessary to support the mass of the well lens 414, the arm 416 simply directs the movement of the well lens 414. In this case, the well lens arm 416 may be substantially minimized in size because it is able to float on a cushion of air between the bottom of the well lens 414 and the surface of the sample well disk 410. It will be understood, however, that the arm 416 may also be substantial enough to hold the well lens 414 above the disk 410.

Various mechanisms for producing the cushion of air are generally known in the computer hard drive arts. Specifically, in a computer hard drive, a magnetic reader floats on a cushion of air formed as the platter of the hard disk begins to rotate. Therefore, the armature simply moves the floating head to the selected area to read the platter. Likewise, the arm 416 moves the well lens 414 to the selected area of the sample well disk 410 to be excited or detected.

Various embodiments further comprise temperature control mechanisms, for example, force convection temperature control mechanisms. Such mechanisms are generally known in the art and include those described in commonly assigned U.S. Pat. No. 5,942,432 entitled, “Apparatus for a Fluid Impingement Thermal Cycler”; and commonly assigned U.S. Pat. No. 5,928,907 entitled, “System for Real Time Detection of Nucleic Acid Application Products” both of which are incorporated herein by reference for all purposes. Temperature control mechanisms may be included to change the temperature of the sample well tray or disk to change the temperature of the samples placed in the sample wells 22.

The temperature control system may be included for several reasons. For example, thermal cycling of the sample or samples may be desirable. That is, it may be desirable to change or cycle the temperature of the samples placed in the sample wells. This may be desirable when particular reactions, such as polymerase change reactions are occurring or being induced or controlled. Alternatively, a selected temperature may be maintained when an electrophoresis system is being used. The temperature of the sample may determine the migration times for the electrophoresis experiment. Also, the samples placed in the sample well 22 may be cooled or heated to produce a more optimum excitation and detection time. Specifically, the sample to be detected may excite more efficiently at a selected temperature and that selected temperature may be obtained with the appropriate temperature control mechanisms.

According to various embodiments, the rotating mirror 42 can also direct the reflected excitation beam to the light detector 90. Therefore, the grading 80 with the lens 82 may not be necessary if the rotating mirror 42 is provided to reflect the excitation beam directly to the light detector. According to various embodiments, this can reduce the size of the optical mechanisms required to provide the reflected excitation beam to the light detector 90.

The light detection device 90 may be any appropriate light detector as described above. The light detection device 90 may be any appropriate device which is able to convert a detected light or energy signal into a usable light signal which is either directly converted to a digital signal or may be converted to a digital signal for further processing.

In various embodiments, a CCD can be used in a plurality of modes. Specifically, one exemplary mode is a Time Delay Integration (TDI) mode. In TDI mode, a weak continuous signal can be amplified with no deterioration in the focus or outline of the signal or image. Specifically, on a continuous CCD, a moving image may appear as a blur on a final image if it is exposed to the entire CCD in a continuous manner. However, using a TDI mode, the CCD can move the collected electrons, formed when energy waves encounter the CCD, along subsequent rows or registers of the CCD allowing the signal to be “clocked” between the rows to gather additional protons to increase the final signal. The rate of the clocking can be matched with the translational rate of the sample well tray. The clocking rate can be matched with the rate of the sample well disk in rotation or can be matched with the read translation of the well lens housing or the floating well lens 414. In addition, the clocking rate can be matched with the translational rate of the lens housing 14 in combination with a linear as opposed to a rotational rate.

Once one of the sample wells 22 is illuminated with the excitation beam, it will continue to emit an emitted excitation beam until the sample well 22 is no longer illuminated by the excitation beam. Generally, the CCD has a continuous read CCD therefore it detects continuously rather than on and off like a shutter for a camera. Therefore, if the sample is moving relative the CCD during the time it is emitting a light beam, the image on the CCD will be blurred or elongated relative to the actual size or number of pixels the image should take on the CCD. In the TDI mode, as soon as the image begins the row is clocked at the rate of the movement of the sample well relative the CCD, therefore the image finally produced by the CCD is substantially similar to the actual number of pixels associated with the image. Therefore, in TDI mode rather than producing a blurred or unfocused image, the CCD can, in effect, multiply the signal being received from each of the individual sample wells and provide a stronger signal to the processing system.

For example, as the sample well disk 310 rotates in the direction θ_{f}, and the sample well is initially illuminated with the excitation beam, the sample in the sample well 22 is excited and may begin to produce a reflected excitation beam. In an embodiment comprising a CCD with TDI mode capability, the first row of pixels receives a signal from the illuminated sample well. As the sample well disk 310 continues to rotate, each successive row of pixels will be illuminated by the reflected excitation beam as long as the sample well is excited by the excitation beam. When not in TDI mode, each of the rows of pixels receives a certain illumination due to the reflected excitation beam from the sample well 22. This may cause an elongated signal as each row receives a portion of the reflected excitation beam.

In TDI mode, however, after the first row of pixels receives a signal, that row is clocked to the next row at a rate to match the rate of the rotation of the sample well disk 310. Therefore, the second row will receive the signal strength from the first row and additional signals from the reflected excitation beam 22 as that row receives the reflected excitation beam. Therefore, the second row actually receives the signal from the previous row and from its own exposure to the sample well. This continues through each of the rows on the CCD each time collecting the light which it receives and adding it to the signal already received by the previous rows. Therefore, the final signal will both be enhanced and have a higher signal to noise ratio.

The rotating mirror 42 or other beam directional devices also may not be necessary. Specifically, if the path of the beam is substantially continuous or can be moved mechanically throughout the reading of the sample well tray, a rotating or directional mirror is not necessary. As exemplary illustrated in FIG. 11 where the sample wells 22 are placed on an internally collapsing spiral 194, the path of the excitation beam is substantially continuous from the beginning to the end of the excitation and detection cycle. With additional references to FIGS. 15a and 15b, the excitation beam can be directed to the single floating well lens 414 throughout the entire excitation and detection cycle. Therefore, the rotating mirror is not necessary to move the excitation beam amongst various well lenses to ensure that the excitation beam is focused on the appropriate sample well 22. Therefore, the excitation detection system can be reduced in complexity. It will be understood that the sample wells 22 of the sample well disk 410 may define one or a plurality of spirals.

According to various embodiments, the size of the sample wells 22 or the well lenses 12 and 414 may vary depending upon the optical excitation and detection system. Specifically, the sample wells 22 may be sized and placed to allow the excitation beam to be properly focused on the sample well 22 for a selected amount of time. Exemplary well sizes may have centers placed between about 5 mm and about 100 micrometers apart. In addition, the size of the lenses may vary depending upon the size of the various sample wells 22 and the amount of light that must reach and be received from the sample well 22. It will be understood, however, that these changes will not be outside the scope of the appended claims.

Other embodiments will be apparent to those skilled in the art from consideration of the specification and the practice thereof. It is intended that the specification and examples be considered as exemplary only, with a true scope and spirit being indicated by the following claims. All documents cited herein are incorporated by reference for any purpose.

What is claimed is:

1. A system to detect fluorescence comprising:
a sample platform;
a plurality of sample wells positioned on said sample platform;
a focusing element selectively alignable with at least one of said sample wells, wherein said focusing element is selectable in an aligned position or an unaligned position relative to at least one of said sample wells;
an excitation source to produce an excitation beam that is focused by said focusing element into a selected holding area when said focusing element is in said aligned position; and
a detection system to detect a selected emitted energy from a sample placed in said sample well;
wherein at least one of said sample platform and said focusing element rotates about a selected axis of rotation to move said focusing element between said aligned position and said unaligned position.

2. The system of claim 1, further comprising:
a directing mirror to assist in selectively aligning said excitation beam.

3. The system of claim 1, wherein said sample wells are arranged on said platform in concentric rings.

4. The system of claim 1, wherein said sample wells are arranged on said platform such that a path through a center of each sample holding area substantially defines an internally collapsing spiral.

5. The system of claim 1, wherein said sample wells are aligned radially outwardly from a center of said platform.

6. The system of claim 1, wherein said platform defines at least one of a circle and a polygon.

7. The system of claim 1, wherein said focusing element comprises a plurality of lenses arranged in a substantially linear orientation.

8. The system of claim 7, wherein said sample platform is rotatable relative to said plurality of lenses such that each sample holding area is alignable with at least one of said lenses.

9. The system of claims 7, wherein said sample platform is rotatable relative to said plurality of lenses such that a selected plurality of said sample wells are aligned with a selected plurality of said lenses simultaneously.

10. The system of claim 1, further comprising:
a splitting element, wherein said excitation energy wave is split into a plurality of excitation energy waves after encountering said splitting element;
wherein a selected plurality of said sample wells are excited simultaneously.

11. The system of claim 1, wherein said sample platform is moveable relative to said detection system.

12. The system of claim 1, wherein said focusing element comprises:
a lens to focus said excitation beam at a selected sample well; and
a lens moving system to move said lens in a selected manner.

13. The system of claim 12, further comprising:
a member operably interconnecting said lens moving system and said lens;
wherein a pressure differential is formed between said platform and said lens as said platform rotates such that said lens does not touch said platform.

14. The system of claim 12, further comprising:
a member operably interconnecting said lens moving system and said lens;
wherein said member holds said lens a distance from said platform such that said lens does not touch said platform as said sample wells are detected.

15. The system of claim 1, wherein said detection system comprises at least one light detection device chosen from a group comprising a charge coupled device, a photo-multiplier tube, a complimentary metal-oxide semiconductor, a photodiode, and an avalanche photodiode.

16. The system of claim 15, wherein said light detection device is a charge coupled device comprising a time-delay-integration mode to increase a signal-to-noise ratio.

17. A system to excite a plurality of sample wells comprising:
an excitation energy source, wherein said excitation energy source is able to produce an initial excitation beam; and
a dividing element to divide said initial excitation beam into a plurality of secondary excitation beams;
wherein a plurality of sample wells are excited substantially simultaneously by said plurality of secondary excitation beams.

18. The excitation system of claim 17, further comprising:
a focusing element comprising a plurality of lenses alignable with a selected plurality of said sample wells.

19. The excitation system of claim 18, wherein said focusing element is capable of a plurality of positions to align said plurality of lenses with said selected plurality of sample wells.

20. The excitation system of claim 18, wherein said focusing element is capable of translation to align said plurality of lenses with said selected plurality of sample wells.

21. The excitation system of claim 17, wherein said dividing element is chosen from at least one of a hologram, a computer generated hologram, a grating, a prism, a fish eye lens, and a beam splitter.

22. A sample platform to be used in an excitation and detection system wherein a plurality of samples may be placed on the sample platform to be excited and detected in a selected manner, the sample platform comprising:
a substantially planar member formed of a material suitable for use in an optical detection system;
a plurality of sample wells positioned on said member; and
an axis of rotation about which said sample wells rotate such that each sample well passes a selected point relative to said member;
wherein said sample wells are arranged in a selected pattern on said member.

23. The sample platform of claim 22, wherein said sample wells are arranged on said member in a plurality of concentric rings.

24. The sample platform of claim 23, wherein said sample wells are arranged on said member such that a path through a center of each sample well substantially defines an internally collapsing spiral.

25. The sample platform of claim 24, wherein said sample wells are arranged on said member such that a path through a center of each sample well substantially defines a plurality of internally collapsing spirals.

26. The sample platform of claim 22, wherein said sample wells are arranged on said member in a radially extending manner.

27. The sample platform of claim 22, wherein said selected point is defined by a detection apparatus spaced a distance from said member;
wherein said member rotates relative to said selected point during operation.

28. The sample platform of claim 22, further comprising:
a detection apparatus including a focusing element;
wherein said focusing element defines said selected point;
wherein said focusing element is able to move relative said axis of rotation.

29. A method of scanning energy emitted by a sample comprising:
providing an excitation source to produce an excitation beam;
providing a focusing element;
providing a sample platform comprising a plurality of sample wells, wherein said sample wells comprise said sample, wherein said plurality of sample wells are positioned on the sample platform, such that the sample wells and the focusing element are alignable relative to one another;
focusing said excitation beam on at least a selected one of said sample wells such that a sample in said selected sample well produces an emitted beam; and
moving at least one of said sample wells about an axis and said excitation beam to allow said excitation beam to be focused on each of said plurality of sample wells.

30. The method of claim 29, wherein moving said sample wells includes rotating the sample platform relative to the light detection device.

31. The method of claim 35, further comprising:
providing a light detection device; and
detecting said emitted beam with said light detection device.

32. The method of claim 29, wherein said focusing element comprises a plurality of lenses, further comprising:
directing said excitation beam sequentially towards each one of said plurality of lenses.

33. The method of claim 32, wherein said plurality of lenses are positioned linearly on said focusing element.

34. The method of claim 29, wherein said focusing element comprises a plurality of lenses, further comprises:
dividing said energy beam into a plurality of excitation beams;
wherein the plurality of excitation beams are directed simultaneously towards said plurality of lenses.

35. The method of claim 34, wherein said plurality of lenses are positioned linearly on said focusing element

36. The method of claims 29, wherein said focusing element comprises a movable lens, and wherein focusing said excitation beam comprises:
moving said movable lens operably with the energy beam to focus the energy beam on a selected sample holding area.

37. The method of claim 36, wherein moving said movable lens comprises:
rotating the sample platform to form a pressure differential to force the movable lens away from the sample platform.
